(19) United States
(12) Patent Application Publication
(10) Pub. No.: US 2003/0175420 A1
(43) Pub. Date: Sep. 18, 2003

(54) Production of adhesive tapes by radiation-chemically crosslinking adhesive-coated tapes and use thereof

(76) Inventor: Norbert Grittner, Hamburg (DE)

Correspondence Address: KURT BRISCOE, NORRIS, MCLAUGHLIN & MARCUS, P.A., 220 EAST 42ND STREET, 30TH FLOOR, NEW YORK, NY, 10017, US

(21) Appl. No.: 10/348,525

(22) Filed: Jan. 21, 2003

(30) Foreign Application Priority Data
Mar. 13, 2002 (DE) 102 11 020.4

(51) Int. Cl. B05D 5/10; B05D 3/06

(52) U.S. Cl. 427/207.1; 427/208.4; 427/532

(57) ABSTRACT

A process for producing adhesive tapes in which an adhesive tape coated with an adhesive is subjected to radiation-chemical crosslinking, especially electron beam crosslinking, irradiation taking place from the side coated with pressure-sensitive adhesive, the acceleration voltage during irradiation being chosen so that the amount of the drop in dose between the adhesive surface facing the radiation source and the surface turned away from it is greater than 40% of the level of dose irradiated on the adhesive surface facing the radiation source.

The invention relates to a process for producing adhesive tapes, in which adhesive tapes coated with an adhesive are subjected to radiation-chemical crosslinking, and to their use.

The crosslinking of pressure-sensitive adhesives (PSAs) by electron beams has long been state of the art. The aim of such irradiation hitherto was to increase the shear strength and cohesion of the subject PSAs to an extent such that sliding off under shear stress or formation of residues on removal from the substrate was prevented. In this context it should be borne in mind particularly that in contrast to thermal crosslinking, generally effected by means of sulfur donors or phenolic resin systems, electron beam crosslinking does not take place uniformly across the whole thickness of the PSA but instead exhibits a pronounced depth profile.

This depth profile is known and is described for PSAs, for example, in U.S. Pat. No. 4,246,297 A1.

It shows a preference for the near-surface regions of the PSA film, whereas the lower layers are generally crosslinked to a lesser extent. This phenomenon is utilized to treat radiation-sensitive backing materials such as fabrics or release papers gently while at the same time effectively crosslinking the layers applied thereon, such as laminating adhesives or polymeric coatings, for example.

Applied to PSA tapes, however, this leads generally, as depicted in EP 0 453 254 A1, to unacceptable adhesive properties in the products, which under a shearing load tend to shear off at the lower-lying, poorly crosslinked layer of the PSA or even to split cohesively at this point when the adhesive tape is removed from the substrate, with the consequence that unwanted residues remain on the substrate.

For this reason, EP 0 453 254 A1 describes electron beam crosslinking such that the drop in dose between the outer surface of the PSA and its interface toward the backing material is to be less than 40% of the surface dose. Uniform deep-down crosslinking is thus ensured, and is described therein as being vital for PSA tapes.

The publication “Druckfarben und Lacktrocknung mit 100 kV-Elektronenstrahlen” [printing ink and varnish drying using 100 kV electron beams] (Schiller, Panzer, Seyfert, Röder, Papier- und Kunststoff Verarbeiter 8/1996) describes an instrument and a process for the electron beam crosslinking of coatings, both instrument and process being distinguished by particularly low acceleration voltages and hence a low depth of electron penetration into the substrate. The publication, however, relates exclusively to applications to the drying of printing inks. The particular requirements of PSAs and their application are not taken into account.

DE 198 46 901 A1 discloses a process for radiation-chemically crosslinking single-sidedly adhesive-coated adhesive tapes, the irradiation of the adhesive tape taking place through the backing material of the adhesive tape onto the adhesive in such a way that the backing material and the side of the adhesive facing the backing material receive a dose of from 30 to 200 kGy, in particular from 50 to 150 kGy, especially 100 kGy, and the acceleration voltage during irradiation being chosen such that on the open side of the adhesive the dose has fallen to from 0 to 60 kGy, in particular from 0 to 50 kGy, especially from 10 to 20 kGy.

DE 198 46 902 A1 discloses a process for radiation-chemically crosslinking double-sided adhesive tapes, in which a backing material coated on both sides with adhesives is irradiated asymmetrically in an irradiation apparatus, from both sides, with different doses.

In one advantageous embodiment, the process for radiation-chemically crosslinking double-sided adhesive tapes comprises the steps of:

a) coating a backing material with an adhesive A,

b) EB-crosslinking the adhesive A/backing subproduct on the adhesive side with a dose A and acceleration voltage A set on the EB unit,

c) lining the adhesive A with a release liner,

d) coating the second side of the backing material with the adhesive B, and

e) EB-irradiating the assembly on the open side of the adhesive B with a dose B and acceleration voltage B set on the EB unit, the side bearing the release liner preferably guided through the electron beam on a chill roll and the dose A and the dose B and/or the acceleration voltage A and the acceleration voltage B being different in value.

For this purpose, first of all, in the case of EB crosslinking, the acceleration voltage and dose for the second irradiation that are to be set on the EB unit are calculated independently of the individual thicknesses of the assembly layers, with total doses of up to 80 kGy or more in the adhesive layers, preferably with the aid of a computer program, in such a way that

a) the dose on the open side of the release liner remains less than 40 kGy, preferably less than 10 kGy,

b) the dose at the release liner/adhesive A boundary remains less than 50 kGy, preferably less than 15 kGy,

c) the surface dose in the adhesive B remains less than (target dose +25%), preferably less than (target dose +15%), and

d) the dose in the backing/adhesive B interlayer remains greater than (target dose −25%), preferably greater than (target dose −15%),

e) while on the other hand the drop in dose in the adhesive B toward the carrier does not exceed 45%, preferably 25%, of the target dose.

Likewise known are the fundamental possibilities for the radiation crosslinking of rubber compositions.

U.S. Pat. No. 2,956,904 A1 sets out how adhesives based on polydiene rubbers/resins, poly(vinyl ethers), polyacrylates, and poly(dimethylsiloxanes) can be crosslinked by exposure to high-energy radiation, with accelerated electrons being used preferably for this purpose. This increases cohesion, leading to a prolonging of the shear stability times particularly at elevated temperatures. In contrast to thermal crosslinking using reactive phenol-formaldehyde resins, in this case the bond strengths (peel strengths) are reduced very little if at all.

The effectiveness of radiation crosslinking is dependent, however, on the molecular weight of the rubber. Accompanying the breakdown of the rubber is a sharp fall in the crosslinking yield. In order to achieve a given degree of crosslinking, however, higher and higher radiation doses are required. Degradation of this kind is necessary, however, if the adhesives are to be processed solventlessly as hotmelts or with small additions of solvent as high solids systems, since otherwise the viscosity would be too high for processing. Breakdown normally takes place during the actual preparation of the adhesives, under the action of shear forces in a mixer or mixing extruder. It can be intensified significantly by introduction of atmospheric oxygen. WO 94/11175 A1 and WO 95/25774 A1 describe a preparation process in which increased degradation of nonthermoplastic elastomers is expected owing to oxygen exposure during the preparation procedure.

In order to achieve the same shear stability times for adhesives comprising highly degraded rubber as for solventborne compositions comprising rubber with low levels of degradation, radiation doses of from 100 to 200 kGy are needed. Such high radiation doses necessitate very powerful, expensive accelarator units and may in certain circumstances substantially impair the mechanical properties of important backings such as paper, OPP (oriented polypropylene) or PVC.

This backing damage can be reduced or prevented only under favorable circumstances, for example, if certain minimum thicknesses are provided for adhesive and backing, by reducing the acceleration voltage and, consequently, the depth of penetration of the radiation.

Furthermore, a number of substances are known which are used for increasing the crosslinking.

DE 23 50 030 A1 and DE 24 55 133 A1 describe polyfunctional acrylates for increasing the crosslinking of pressure-sensitive hotmelts based on EVAc and acrylic copolymers, while U.S. Pat. No. 4,133,731 A1 describes such systems based on SIS and SBS block copolymers. The additions run to an order of magnitude of from 5% by weight to 20% by weight.

The known crosslinkers such as triallyl cyanurate (TAC) and bismalimide, which is also used in WO 94/11175 A1 and WO 95/25774 A1, are much less effective at increasing the crosslinking yield of adhesives based on nonthermoplastic diene rubbers such as natural rubbers (NR), synthetic polyisoprene rubbers (IR), and random styrene-butadiene rubbers (SBR) in combination with tackifier resins. Although trifunctional mercaptans, which are used for crosslinking SIS and SBS block copolymers (see WO 88/01281 A1), do achieve sufficient crosslinking in these rubber compositions, they disseminate a very unpleasant odor, particularly when hotmelts are heated, which can be perceived as highly disruptive.

It is known, moreover, that in the case of acrylates a crosslinking step is required in order to set specific adhesive properties.

It is also known that, as the extent of crosslinking goes up, the solubility of rubbers and acrylates in organic solvents is reduced.

In many cases, however, an improvement in the cohesion and solvent resistance after electron beam crosslinking (EB crosslinking) is accompanied by a marked fall in bond strength and tack.

The dose depth profile in a product irradiated in an electron beam unit is known for given acceleration voltages. Various authors have developed empirical functions to describe it (see, for example, Heger, beta-gamma 1, 20,1990 or Neuhaus-Steinmetz, RadTech Europe, Mediterraneo, 1993).

A basis used for calculating the radiation dose is, for example, the following empirical formula, which was published by Neuhaus-Steinmetz at RadTech Europe, Mediterraneo 1993.

$$D [ \% ] = \frac{exp \{ - {( \frac{18 , 8 * X}{{( {U}_{B} )}^{1 , 57}} - 0 , 7 )}^{2} \}}{1 + {( \frac{9 , 7 * X}{{( {U}_{B} )}^{1 , 57}} )}^{15}}$$

where

D is th e dose in %

U_{B} is the acceleration voltage in kV

X i s the irradiated weight per unit area in g/m²,

consisting of the weight per unit area of the vacuum window, the air gap between vacuum window and product, and the depth in the product

For products which are composed of a coating to be irradiated, which may also be a PSA, and a radiation-degradable backing, it is known to optimize the acceleration voltage. In this case the backing receives a significantly lower average dose than the coating, while the dose reduction in the coating is still within an acceptable range for uniform crosslinking (Karmann, 7th Munich Adhesives and Finishing Seminar, 1982; EP 0 453 254 A1).

It is an object of the invention to provide a process which, during the electron beam crosslinking of a PSA-coated backing material, reduces the damage to the adhesive and to the backing material without the quality of the adhesive tape being impaired by inadequate crosslinking of parts of the adhesive, and which does not have the disadvantages of the state of the art, or at least not to the same extent.

This object is achieved by means of a process as detailed in the main claim. The subclaims describe advantageous embodiments of the process. Further embraced by the concept of the invention are adhesive tapes produced by the process of the invention, and the use of these tapes.

The invention accordingly provides a process for producing adhesive tapes in which an adhesive tape coated with an adhesive is subjected to radiation-chemical crosslinking, especially electron beam crosslinking, irradiation taking place from the side coated with pressure-sensitive adhesive, the acceleration voltage during irradiation being chosen so that the amount of the drop in dose between the adhesive surface facing the radiation source and the surface turned away from it is greater than 40% of the level of dose irradiated on the adhesive surface facing the radiation source.

In advantageous embodiments of the adhesive tape a release lacquer coating is applied to the backing material side which is not coated with adhesive and/or a primer is applied between the adhesive and the backing material.

With further preference, an adhesive is applied to the second side of the backing material as well.

The adhesives are preferably composed of at least one elastomer, especially an electron-beam crosslinkable elastomer, such as acrylates, silicone elastomers, natural rubber systems, styrene block copolymers such as styrene-butadiene-styrene, styrene-isoprene-styrene or styrene-ethylene-butylene-styrene, alone or in combination with tackifiers, from solution or dispersion or as a hotmelt.

With further preference at least one tackifier resin, fillers and/or further auxiliaries such as antioxidants, plasticizers or crosslinking auxiliaries are added to the adhesive.

The adhesives may further be filled, colored and/or foamed.

The elastomer is advantageously chosen from the group of the natural rubbers or of the synthetic rubbers or is composed of any desired blend of natural and/or synthetic rubbers, the natural rubber or rubbers being selectable in principle from all available grades such as, for example, crepe, RSS, ADS, TSR or CV types, depending on required purity and viscosity, and the synthetic rubber or rubbers being selectable from the group of randomly copolymerized styrene-butadiene rubbers (SBR), butadiene rubbers (BR), synthetic polyisoprenes (IR), butyl rubbers (IIR), halogenated butyl rubbers (XIIR), acrylic rubbers (ACM), ethylene-vinyl acetate (EVA) copolymers and polyurethanes and/or blends thereof.

With further preference, the processing properties of the elastomers may be enhanced by adding to them thermoplastic elastomers with a weight fraction of from 10 to 50% by weight, based on the total elastomer fraction.

As representatives mention may be made at this point, in particular, of the especially compatible styrene-isoprene-styrene (SIS) and styrene-butadiene-styrene (SBS) types.

Further suitable adhesives include low molecular mass acrylic hotmelts, namely copolymers of (meth)acrylic acid and esters thereof having from 1 to 25 carbon atoms, maleic, fumaric and/or itaconic acid and/or esters thereof, substituted (meth)acrylamides, maleic anhydride, and other vinyl compounds, such as vinyl esters, especially vinyl acetate, vinyl alcohols and/or vinyl ethers.

The acrylic hotmelts may further be blended with one or more additives such as aging inhibitors, crosslinkers, light stabilizers, ozone protectants, fatty acids, resins, plasticizers, and accelerators.

As tackifying resins it is possible without exception to use all known tackifier resins which have been described in the literature. Representatives that may be mentioned include the silicone resins, rosins, their disproportionated, hydrogenated, polymerized, esterified derivatives and salts, the aliphatic and aromatic hydrocarbon resins, terpene resins, and terpene-phenolic resins. Any desired combinations of these and other resins may be used in order to adjust the properties of the resulting adhesive in accordance with what is desired. Explicit reference is made to the depiction of the state of the art in the “Handbook of Pressure Sensitive Adhesive Technology” by Donatas Satas (van Nostrand, 1999).

“Hydrocarbon resin” is a collective term for thermoplastic polymers which are colorless to intense brown in color and have a molar mass of generally about 2 000 to 4 000.

They may be divided into three main groups according to their provenance: petroleum resins, coal tar resins, and terpene resins. The most important coal tar resins are the coumarone-indene resins. The hydrocarbon resins are obtained by polymerizing the unsaturated compounds that can be isolated from the raw materials.

Included among the hydrocarbon resins are also polymers obtainable by polymerizing monomers such as styrene and/or by means of polycondensation (certain formaldehyde resins), with a correspondingly low molar mass. Hydrocarbon resins are products with a softening range that varies within wide limits from <0° C. (hydrocarbon resins liquid at 20° C.) to >200° C. and with a density of from about 0.9 to 1.2 g/cm³.

They are soluble in organic solvents such as ethers, esters, ketones, and chlorinated hydrocarbons, and are insoluble in alcohols and water.

By rosin is meant a natural resin which is recovered from the crude resin from conifers. Three types of rosin are differentiated: balsam resin, as a distillation residue of turpentine oil; root resin, as the extract from conifer root stocks; and tall resin, the distillation residue of tall oil. The most significant in terms of quantity is balsam resin.

Rosin is a brittle, transparent product with a color ranging from red to brown. It is insoluble in water but soluble in many organic solvents such as (chlorinated) aliphatic and aromatic hydrocarbons, esters, ethers, and ketones, and also in plant oils and mineral oils. The softening point of rosin is situated within the range from approximately 70 to 80° C.

Rosin is a mixture of about 90% resin acids and 10% neutral substances (fatty acid esters, terpene alcohols, and hydrocarbons). The principal rosin acids are unsaturated carboxylic acids of empirical formula C₂₀H₃₀O₂, abietic, neoabietic, levopimaric, pimaric, isopimaric, and palustric acid, as well as hydrogenated and dehydrogenated abietic acid. The proportions of these acids vary depending on the provenance of the rosin.

Plasticizers which can be used are all plasticizing substances known from adhesive tape technology. They include, inter alia, the paraffinic and naphthenic oils, (functionalized) oligomers such as oligobutadienes and oligoisoprenes, liquid nitrile rubbers, liquid terpene resins, animal and vegetable oils and fats, phthalates, and functionalized acrylates.

For the purpose of heat-induced chemical crosslinking, which can be used additionally to electron beam crosslinking, it is possible to use all known heat-activatable chemical crosslinkers such as accelerated sulfur or sulfur donor systems, isocyanate systems, reactive melamine resins, formaldehyde resins, and (optionally halogenated) phenol-formaldehyde resins and/or reactive phenolic resin or diisocyanate crosslinking systems with the corresponding activators, epoxidized polyester resins and acrylic resins, and combinations thereof.

The crosslinkers are preferably activated at temperatures above 50° C., in particular at temperatures from 100° C. to 160° C., with very particular preference at temperatures from 110° C. to 140° C.

The thermal excitation of the crosslinkers may also be effected by means of IR rays or high-energy alternating fields.

Fillers are, for example, chalk, zinc oxides, silicates or other minerals, such as are widely known within the field of pressure-sensitive adhesives.

The adhesives are coated onto the backing materials by a known method, for example, by means of a doctor blade, with or without application of solvents, or as a dispersion, and are dried where appropriate, the adhesive in one outstanding embodiment of the invention being applied at a weight per unit area of from 10 to 200 g/m², preferably from 30 to 120 g/m² and, very preferably, from 30 to 60 g/m², to the backing material.

Suitable backing materials include all known backings, especially laminates, foamed and unfoamed films and/or spunbondeds or nonwovens based on polyethylene, polypropylene, monoaxially or biaxially oriented polypropylene, polyester, PA, PVC or other common copolymers or on cellulosic materials such as creped and uncreped papers or viscose staple and/or cotton wovens, knits or nonwovens, foam materials in web form, made of polyethylene and polyurethane, for example, or where appropriate with corresponding chemical or physical surface pretreatment of the coating side and antiadhesive physical treatment or coating of the reverse.

With further preference, the backing material in web form is a double-sidedly antiadhesively coated material such as a release paper or a release film.

This backing material has a basis weight of from 12 to 250 g/m² or more, preferably from 12 to 150 g/m², and, with very particular preference, from 12 to 100 g/m².

As backing material for the adhesive tape it is also possible to use all known textile backings such as wovens, knits or nonwoven webs; the term “web” embraces at least textile sheetlike structures in accordance with EN 29092 (1988) and also stitchbonded nonwovens and similar systems.

It is likewise possible to use spacer fabrics, including wovens and knits, with lamination. Spacer fabrics of this kind are disclosed in EP 0 071 212 B1. Spacer fabrics are matlike layer structures comprising a cover layer of a fiber or filament fleece, an underlayer and individual retaining fibers or bundles of such fibers between these layers, said fibers being distributed over the area of the layer structure, being needled through the particle layer, and joining the cover layer and the underlayer to one another. As an additional though not mandatory feature, the retaining fibers in accordance with EP 0 071 212 B1 comprise inert mineral particles, such as sand, gravel or the like, for example.

The holding fibers needled through the particle layer hold the cover layer and the underlayer at a distance from one another and are joined to the cover layer and the underlayer.

Spacer wovens or spacer knits are described, inter alia, in two articles, namely

an article from the journal kettenwirk-praxis 3/93,1993, pages 59 to 63, “Raschelgewirkte Abstandsgewirke” [Raschel-knitted spacer knits]and

an article from the journal kettenwirk-praxis 1/94,1994, pages 73 to 76, “Raschelgewirkte Abstandsgewirke”,

the content of said articles being included here by reference and being part of this disclosure and invention.

Suitable nonwovens include, in particular, consolidated staple fiber webs, but also filament webs, meltblown webs, and spunbonded webs, which generally require additional consolidation. Known consolidation methods for webs are mechanical, thermal, and chemical consolidation. Whereas with mechanical consolidations the fibers are usually held together purely mechanically by entanglement of the individual fibers, by the interlooping of fiber bundles or by the stitching-in of additional threads, it is possible by thermal and by chemical techniques to obtain adhesive (with binder) or cohesive (binderless) fiber-fiber bonds. Given appropriate formulation and an appropriate process regime, these bonds may be restricted exclusively, or at least predominantly, to the fiber nodal points, so that a stable, three-dimensional network is formed while retaining the loose open structure in the web.

Webs which have proven particularly advantageous are those consolidated in particular by overstitching with separate threads or by interlooping.

Consolidated webs of this kind are produced, for example, on stitchbonding machines of the “Malifleece” type from the company Karl Meyer, formerly Malimo, and can be obtained, inter alia, from the companies Naue Fasertechnik and Techtex GmbH. A Malifleece is characterized in that a cross-laid web is consolidated by the formation of loops from fibers of the web.

The backing used may also be a web of the Kunit or Multiknit type. A Kunit web is characterized in that it originates from the processing of a longitudinally oriented fiber web to form a sheetlike structure which has the heads and legs of loops on one side and, on the other, loop feet or pile fiber folds, but possesses neither threads nor prefabricated sheetlike structures. A web of this kind has been produced, inter alia, for many years, for example on stitchbonding machines of the “Kunitvlies” type from the company Karl Mayer. A further characterizing feature of this web is that, as a longitudinal-fiber web, it is able to absorb high tensile forces in the longitudinal direction. The characteristic feature of a Multiknit web relative to the Kunit is that the web is consolidated on both the top and bottom sides by virtue of the double-sided needle punching.

Finally, stitchbonded webs are also suitable as an intermediate for forming the backing material. A stitchbonded web is formed from a nonwoven material having a large number of stitches extending parallel to one another. These stitches are brought about by the incorporation, by stitching or knitting, of continuous textile threads. For this type of web, stitchbonding machines of the “Maliwatt” type from the company Karl Mayer, formerly Malimo, are known.

Also particularly advantageous is a staple fiber web which is mechanically preconsolidated in the first step or is a wet-laid web laid hydrodynamically, in which between 2% and 50% of the web fibers are fusible fibers, in particular between 5% and 40% of the fibers of the web.

A web of this kind is characterized in that the fibers are laid wet or, for example, a staple fiber web is preconsolidated by the formation of loops from fibers of the web or by needling, stitching or air-jet and/or water-jet treatment.

In a second step, thermofixing takes place, with the strength of the web being increased again by the (partial) melting of the fusible fibers.

The web backing may also be consolidated without binders, by means for example of hot embossing with structured rolls, with properties such as strength, thickness, density, flexibility, and the like being controllable via the pressure, temperature, residence time, and embossing geometry.

For the inventive use of nonwovens, the adhesive consolidation of mechanically preconsolidated or wet-laid webs is of particular interest, it being possible for said consolidation to take place by way of the addition of binder in solid, liquid, foamed or pastelike form. A great diversity of theoretical embodiments is possible: for example, solid binders as powders for trickling in; as a sheet or as a mesh, or in the form of binding fibers. Liquid binders may be applied as solutions in water or organic solvent or as a dispersion. For adhesive consolidation, binder dispersions are predominantly chosen: thermosets in the form of phenolic or melamine resin dispersions, elastomers as dispersions of natural or synthetic rubbers, or, usually, dispersions of thermoplastics such as acrylates, vinyl acetates, polyurethanes, styrene-butadiene systems, PVC, and the like, and also copolymers thereof. Normally, the dispersions are anionically or nonionically stabilized, although in certain cases cationic dispersions may also be of advantage.

The binder may be applied in a manner which is in accordance with the prior art and for which it is possible to consult, for example, standard works of coating or of nonwoven technology such as “Vliesstoffe” (Georg Thieme Verlag, Stuttgart, 1982) or “Textiltechnik-Vliesstofferzeugung” (Arbeitgeberkreis Gesamttextil, Eschborn, 1996).

For mechanically preconsolidated webs which already possess sufficient composite strength, the single-sided spray application of a binder is appropriate for effecting specific changes in the surface properties.

Such a procedure is not only sparing in its use of binder but also greatly reduces the energy requirement for drying. Since no squeeze rolls are required and the dispersion remains predominantly in the upper region of the web material, unwanted hardening and stiffening of the web can very largely be avoided.

For sufficient adhesive consolidation of the web backing, the addition of binder in the order of magnitude of from 1% to 50%, in particular from 3% to 20%, based on the weight of the fiber web, is generally required.

The binder may be added as early as during the manufacture of the web, in the course of mechanical preconsolidation, or else in a separate process step, which may be carried out in-line or off-line. Following the addition of the binder it is necessary temporarily to generate a condition in which the binder becomes adhesive and adhesively connects the fibers—this may be achieved during the drying, for example, of dispersions, or else by heating, with further possibilities for variation existing by way of areal or partial application of pressure. The binder may be activated in known drying tunnels, or else, given an appropriate selection of binder, by means of infrared radiation, UV radiation, ultrasound, high-frequency radiation or the like. For the subsequent end use it is sensible, although not absolutely necessary, for the binder to have lost its tack following the end of the web production process. It is advantageous that, as a result of the thermal treatment, volatile components such as fiber assistants are removed, giving a web having favorable fogging values so that when a low-fogging adhesive is used it is possible to produce an adhesive tape having particularly advantageous fogging values.

A further, special form of adhesive consolidation consists in activating the binder by incipient dissolution or swelling. In this case it is also possible in principle for the fibers themselves, or admixed special fibers, to take over the function of the binder. Since, however, such solvents are objectionable on environmental grounds, and/or are problematic in their handling, for the majority of polymeric fibers, this process is not often employed.

Knitted fabrics are textile sheetlike structures produced from one or more threads or thread systems by intermeshing (interlooping), in contrast to woven fabrics, which are produced by intersecting two thread systems (warp and weft threads), and nonwovens (bonded fiber fabrics), where a loose fiber web is consolidated by heat, needling or stitching or by means of water jets.

Knitted fabrics can be divided into weft knits, in which the threads run in transverse direction through the textile, and warp knits, where the threads run lengthwise through the textile. As a result of their mesh structure, knitted fabrics are fundamentally pliant, conforming textiles, since the meshes are able to stretch lengthways and widthways, and have a tendency to return to their original position. In high-grade material, they are very robust.

Starting materials envisaged for the textile carrier include, in particular, polyester, polypropylene, viscose or cotton fibers. The invention is, however, not restricted to said materials; rather it is possible to use a large number of other fibers to produce the textile backing, this being evident to the skilled worker without any need for inventive activity.

Low flammability in the adhesive tape may be achieved by adding flame retardants to the backing material and/or to the adhesive. These retardants may be organobromine compounds, together where appropriate with synergists such as antimony trioxide; however, with a view to the absence of halogens from the adhesive tape, preference will be given to using red phosphorus, organophosphorus compounds, mineral compounds or intumescent compounds such as ammonium polyphosphate, alone or in conjunction with synergists.

Where the adhesive tape is to be used in its preferred utility, as adhesive masking tape, the backing material is in particular a stretchable paper backing in web form. Stretchability in particular is vital property of adhesive masking tapes. It alone allows crease-free blanket bonding in curves and on spherical surfaces, such as is needed, for example, when refinishing automobiles; in manual application, the adhesive masking tape can be made to follow gentle contours perfectly, and so leads to a clean paint edge with no underruns. The stretch necessary for this purpose is in the region of 10% in the case of what is known as flat crepe, around 50% in the case of what is known as high crepe. Tensile strength and stretching are tailored to one another so that it is readily possible, during manual application, to remove a part of the stretch on the outer curve of the adhesive masking tape without risk of cracking, and so to produce a curve.

The text below addresses the typical operations involved in the production of stretchable paper backings in web form.

The backing material typically used for adhesive marking tapes comprises mechanically creped papers which are generally produced from 100% sodium kraft pulp. In the process known as wet creping, creping takes place generally on the paper machine with the aid of a creping doctor, on what is termed a creping cylinder either within or at the end of the press section or on one of the following cylinders of the dry section. By compressing the paper web on the leading edge of the creping doctor while the paper is still wet and labile, microcreasing is produced in the paper. This highly sensitive process step generally limits the maximum possible speed of the paper machine and shortens the length of the paper web by about 10 to 20%. In the course of the subsequent drying operation, the creases are fixed substantially by the formation of hydrogen bonds, so that when the paper is mechanically stressed to a moderate extent in the longitudinal direction—such as occurs, for example, when an adhesive masking tape is unrolled and cut to length—the creases remain stable. The stability can be increased further by adding sizing agents, and so adapted to the particular end use. It is normally determined by measuring the stress/strain diagram. In accordance with this process it is possible to produce flat crepe having elongations at break of up to 20%.

Another process for producing stretchable paper backings for adhesive masking tapes is the so-called CLUPAK process. Here, the fibers in the smooth paper are puckered or compressed in the plane of the paper web by friction, by means of a destretching rubber cloth or rubber-coated rollers. The product is a stretchable paper whose puckered fibers can be extended again under tensile stress. Microcreasing as described above cannot be discerned; the paper appears smooth and is therefore not to be regarded as crepe paper in the true sense. A characteristic of the papers produced by this process is a tensile strength which is already very high under low stretch and which increases further only slightly in the region of elongation at break. Consequently, in manual application, there is virtually no conformability of adhesive masking tape produced from such papers to spherical surfaces. Moreover, as a result of the process, the paper is highly compacted in the z direction and is therefore poor at absorbing dispersions in the course of the impregnation that is a common part of adhesive masking tape manufacture. Normally, therefore, sized Clupak backings without impregnation are employed for adhesive masking tape. The stretch obtained is likewise up to 20%. Regarding this process and its product, reference may be made to DE 38 35 507 A1.

For achieving very high stretch levels of up to about 50%, it is common to employ the dry creping process. Here, a smooth paper is creped on a separate machine after remoistening with a binder solution (starch, CMC, PVAI), as described above, and then dried again. This produces what are known as high crepes, which in addition to the extreme stretchability are notable for a high thickness and a very rough surface.

In order to increase the strength and imperviousness, the papers which have been made stretchable by various processes, and uncreped papers as well, can be soaked and dried (impregnated) with aqueous dispersions of synthetic or natural polymers or solutions thereof in organic solvents, coated with primer for better anchoring of the PSA layer, and provided with a release layer on the side opposite the primer, for the purpose of making the rolls amemable to unwinding.

Backing material produced in one of the ways described is coated with the pressure-sensitive adhesive. This coating takes place appropriately on the side of the backing which is opposite the release layer, and which may, where appropriate, have been coated with an adhesive promoter. Where there is no need for a release layer, the side to be coated with pressure-sensitive adhesive can be chosen according to other criteria. The nature and composition of the pressure-sensitive adhesives in question have already been described above in detail in accordance with the state of the art.

To meet the requirements, but in particular to enhance the temperature resistance, it is necessary in some fields of application to crosslink the adhesive after it has been applied to the backing material and dried where appropriate.

In addition to chemical crosslinking processes, which will not be addressed any further here, crosslinking can be carried out with electron beams (EB), UV or IR rays, provided the adhesive has been appropriately prepared for that purpose.

Typical irradiation apparatus employed in the inventive embodiment of the process includes linear cathode systems, scanner systems or multiple longitudinal cathode systems, insofar as electron beam accelerators are concerned.

The acceleration voltages are situated in the range between 40 kV and 350 kV, preferably from 70 kV to 300 kV. The irradiated dose ranges between 5 and 150 kGy, in particular from 10 to 90 kGy. By the dose here is meant that dose which is measured on the surface of the irradiated product; it is also referred to as the surface dose.

The correct construction of the electron accelerator and the correct choice of the crosslinking parameters of dose and acceleration voltage are required to ensure that on the one hand the pressure-sensitive adhesive receives a surface dose sufficient to achieve temperature stability, of more than 5 kGy but not more than 150 kGy, and on the other hand the radiation-sensitive backing material is exposed to the lowest possible dose.

This is especially the case when the acceleration voltage, the thickness of the titanium window of the electron accelerator, and the size of the air gap between titanium foil and the facing side of the adhesive are chosen such that the magnitude of the fall in dose between the adhesive surface facing the radiation source and the surface remote from it is greater than 40% of the magnitude of the dose which is incident on the adhesive surface remote from the radiation source, but in particular greater than 45%.

The required acceleration voltages are dependent on the thickness of the PSA film and its density and also on the construction of the electron accelerator itself, particularly on the density and thickness of the window material separating the vacuum of the electron accelerator from the external atmosphere, and also on the width and filling gas of the gap between the window and the PSA surface facing the window.

For adhesive tapes which are to be removed without residue following use, particularly said adhesive masking tapes, it is surprisingly found that even in the case of an inventive drop in dose between outer PSA surface and its interface toward the backing material of greater than 40%, the function of these adhesive masking tapes is not impaired but instead, on the contrary, is influenced advantageously by the invention.

That is the case in particular because the application of these masking tapes on the one hand is associated with relatively low shearing loads and on the other hand imposes particular requirements on the crosslinking of the adhesive surface and the tensile strength of the backing materials. As compared with the state of the art, adhesive marking tapes produced by a process of the invention exhibit markedly reduced evidence of deposits and residues following removal from the substrate; when bonded in curves and on spherical surfaces they are more stretchable and thus more conforming; on removal from the substrate they exhibit significantly less frequent tearing while nevertheless, surprisingly, do not fail as a result of shearing off under shearing loads, such as occur, for example, under the inherent stress of a stretch-bonded paper backing. This is related to the fact that the abovementioned mechanical stresses on a stretched crepe paper backing are generally less than those of stretched film backings, since these papers are less elastic.

In the manner depicted in accordance with the invention, products are obtained

which, owing to the particularly gentle mode of irradiation according to the process, and despite effective crosslinking of the upper layer of the PSA and a crosslinking of the PSA interface which faces the backing that is lower by more than 40% in relation to said first crosslinking, surprisingly exhibit no cohesive failure in use, as a result, for example, of formation of residues when the products are removed after bonding,

whose backings, which are sensitive to electron beams, are nevertheless damaged to such a small extent by the electron beams that they exhibit far less-reduced ultimate tensile strengths and stretch values and also reduced damage of any release varnish layer that may be present on the reverse, than was known in accordance with the existing state of the art.

Conversely, for a given level of acceptable damage to the backing material by electron beam crosslinking in accordance with conventional technology, the crosslinking of the topmost PSA layers can be increased significantly, thereby greatly expanding the field of use of these adhesive tapes in the direction of higher application temperatures.

A prerequisite for residue-free removal behavior on the part of adhesive tapes crosslinked in accordance with the invention is a field shear strength on the part of the adhesive that is sufficient even in the uncrosslinked state, such as may be achieved, for example, by adding reinforcing fillers or by a particularly low level of degradation of the elastomer in the production operation. The process is therefore employed preferably for producing PSA tapes which are not subject to particularly high shearing load, i.e., in particular adhesive masking tapes.

The surprising and particularly desirable product properties may, furthermore, be achieved with unusually high web speeds during crosslinking, by virtue of the fact that in the process of the invention the amount of heat which is to be removed on the reverse of the adhesive, caused by the dose to the reverse side, is particularly low. As a consequence, for a given cooling performance of the chill roll opposite the electron accelerator, higher web speeds can be achieved without causing thermal damage to the crosslinked product.

A further advantage of the process of the invention consists, as is known from the publication by Neuhaus-Steinmetz at RadTech Europe, Mediterraneo 1993, in that, since the dose output of electron sources in the claimed range of acceleration voltages is normally much greater than in the case of higher acceleration voltages, higher web speeds can be achieved by this means too, for a given crosslinking dose and given electron accelerator.

Finally, the invention embraces an adhesive tape, particularly a single-sided adhesive tape, obtained by the process of the invention.

In the text below, processes of the invention and adhesive tapes produced by the process of the invention will be illustrated with reference to a number of examples, without thereby wishing to restrict the invention unnecessarily.

### EXAMPLES

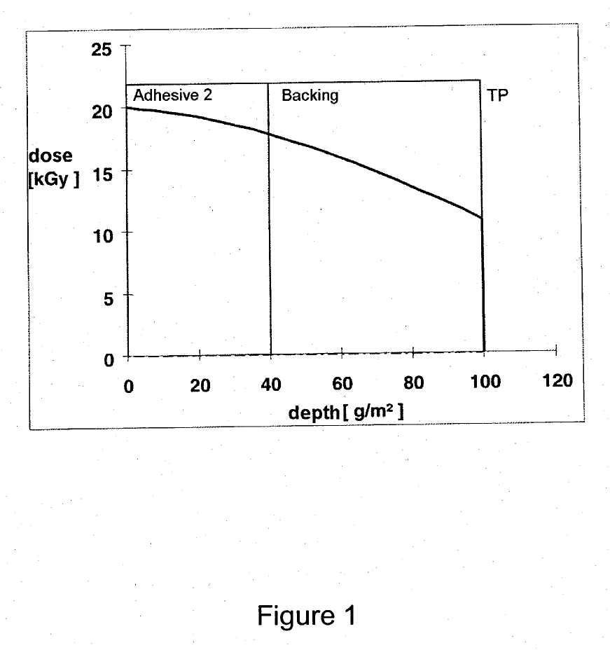

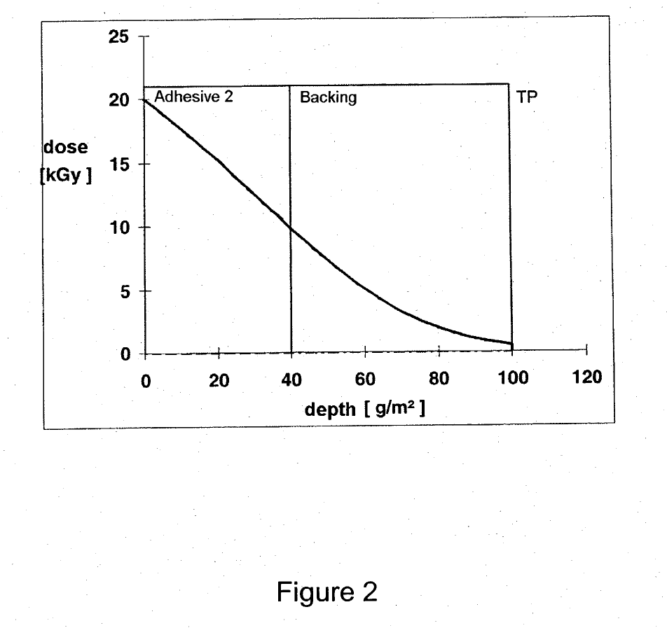

The difference in the depth dose profiles of a product structure typical for crepe masking tapes, comprising 40 g/m² PSA and 60 g/m² impregnated crepe paper coated with release varnish, is illustrated in FIGS. 1 and 2.

In FIG. 1 an acceleration voltage of 150 kV and a dose of 20 kGy are set; in FIG. 2 the values are 110 kV and 20 kGy.

As a result of the acceleration voltage, reduced by 40 kV, and with an identical surface dose, the drop in dose in the adhesive is increased from about 10% to about 50% and thus the damaging average backing dose is effectively reduced from about 14 kGy to below 5 kGy.

The effects of an inventive drop in dose, exceeding 40%, in the pressure-sensitive adhesive, which are detected in the product properties, are illustrated in examples 1 to 10.

Product Structure:

40 g/m² pressure-sensitive adhesive based on natural rubber,

60 g/m² crepe backing, impregnated and coated with release layer

TABLE 1
Examples 1 to 10

| | Surface | Acceleration | Dose drop in | Average | Ultimate tensile | Elongation |
|---|---|---|---|---|---|---|
| | dose | voltage | the adhesive* | backing dose* | stress strength | at break |
| | [kGy] | [kV] | [%] | [kGy] | [N/cm] | [%] |
| 1. | 20 | 180 | 2 | 18 | 45.5 | 10.7 |
| 2. | 20 | 160 | 7 | 16 | 46.0 | 11.0 |
| 3. | 20 | 140 | 17 | 13 | 46.8 | 11.5 |
| 4. | 20 | 130 | 25 | 9 | 47.4 | 12.0 |
| 5. | 20 | 118 | 40 | 6 | 48.2 | 12.4 |
| 6. | 20 | 110 | 55 | 4 | 49.0 | 12.7 |
| 7. | 20 | 100 | 76 | 2 | 50.8 | 13.0 |
| 8. | 15 | 100 | 76 | 1.5 | 51.3 | 13.1 |
| 9. | 10 | 100 | 76 | 1 | 51.7 | 13.1 |
| 10. | 5 | 100 | 76 | 0.5 | 52.0 | 13.2 |
| 11. | 0 | 0 | 0 | 0 | 52.5 | 13.3 |

* = calculated

Specimens of an uncrosslinked PSA tape with crepe backing were crosslinked by electron beams with different settings. On the basis of the crosslinked specimens an investigation was made into the extent to which the irradiation conditions effect the mechanical strength of the PSA tape.

From table 1 it is evident how the average backing dose increases with the surface dose and the acceleration voltage. While as a result of physical laws the average backing dose is relatively voltage-independent at very high (>160 kV) and very low (<110 kV) acceleration voltages, it is highly voltage-dependent in the middle voltage range.

Examples 1 to 10 show that this is true not only of the average backing dose but also, equally, of the mechanical strength and stretchability of the backing. In order to conserve the strength, therefore, it is necessary to operate at acceleration voltages which produce a drop in dose of more than 40% in the adhesive. In that case the average backing dose is so low that the residual damage to the backing material does not substantially impair the function of the adhesive tape.

Product Structure:

40 g/m² pressure-sensitive adhesive based on natural rubber,

60 g/m² crepe backing, impregnated and coated with release layer

TABLE 2
Example 11 to 20

| | | Acceler- | Dose drop | | |
|---|---|---|---|---|---|
| | Surface | ation | in the | Adhesive | Residues after |
| | dose | voltage | adhesive | residues** | temperature loading* |
| | [kGy] | [kV] | [%] | [%] | [%] |
| 12. | 20 | 180 | 2 | 0 | 0 |
| 13. | 20 | 160 | 7 | 0 | 0 |
| 14. | 20 | 140 | 17 | 0 | 0 |
| 15. | 20 | 130 | 25 | 0 | 0 |
| 16. | 20 | 118 | 40 | 0 | 0 |
| 17. | 20 | 110 | 55 | 0 | 0 |
| 18. | 20 | 100 | 76 | 0 | 0 |
| 19. | 15 | 100 | 76 | 0 | 3 |
| 20. | 10 | 100 | 76 | 0 | 7 |
| 21. | 5 | 100 | 76 | 0 | 12 |
| 22. | 0 | 0 | 0 | 0 | 20 |

**after 24 h on painted steel sheet
*after 1 h at 80° C. on painted steel sheet

The specimens from examples 1 to 10 were bonded to painted steel panels and removed after 24 h at room temperature of 1 h at 100° C. This is intended to demonstrate the effect of the crosslinking conditions on the development of residue.

Table 2 demonstrates that even in the uncrosslinked state the pressure-sensitive adhesive can be removed without residue at room temperature. After 1 h at 80° C., however, it exhibits adhesive residues which are unacceptable for an adhesive masking tape and so cannot be used, for example, in the refinishing of automobiles. This can be countered by the crosslinking process of the invention without substantially impairing the mechanical load-bearing capacity of the backing material (see table 1). Irradiating conditions more intensive than those of the invention, therefore, constitute a load which is excessive for the performance capacity of the pressure-sensitive adhesive and which is damaging to the backing.

What is claimed is:

1. A process for producing an adhesive tape comprising subjecting an adhesive tape coated on at least one side with a pressure-sensitive adhesive to a radiation-chemical crosslinking, wherein the adhesive tape is subjected to irradiation from a radiation source directed towards a first side of the adhesive tape with a pressure-sensitive adhesive, an acceleration voltage during the irradiation being selected so that an amount of a drop in radiation dose between said first side and a side of the adhesive tape opposite said first side is greater than 40% of a level of a radiation dose irradiated on the first side.

2. The process according to claim 1, wherein the pressure-sensitive adhesive comprises an electron-beam crosslinkable elastomer.

3. The process according to claim 2, wherein the electron-beam crosslinkable elastomer is selected from the group consisting of acrylates, silicone elastomers, natural rubber systems, and styrene block copolymers, each optionally in combination with one or more tackifiers.

4. The process according to claim 3, wherein the styrene block copolymers are selected from styrene-butadiene-styrene, styrene-isoprene-styrene and styrene-ethylene-butylene-styrene.

5. The process according to claim 1, wherein the pressure sensitive adhesive is filled, colored and/or foamed.

6. The process according to claim 1, wherein the adhesive tape comprises a backing material selected from the group consisting of films and/or nonwovens.

7. The process according to claim 6, wherein the backing material comprises a nonwoven based on polyvinyl chloride, polypropylene, polyethylene, polyester or another copolymer of cellulosic materials.

8. The process according to claim 6, wherein the copolymer of cellulosic materials is selected from papers and cotton wovens, knits and nonwovens.

9. The process according to claim 6, wherein the backing material has a basis weight of at least 12 to 250 g/m2.

10. The process according to claim 9, wherein the backing material has a basis weight of from 12 to 150 g/m2.

11. The process according to claim 10, wherein the backing material has a basis weight of from 12 to 100 g/m2.

12. The process according to claim 6, wherein the pressure-sensitive adhesive is applied to the backing with a weight per unit area of from 10 to 200 g/m2.

13. The process according to claim 12, wherein the pressure-sensitive adhesive is applied to the backing with a weight per unit area of from 30 to 120 g/m².

14. The process according to claim 13, wherein the pressure-sensitive adhesive is applied to the backing with a weight per unit area of from 30 to 60 g/m².

15. An adhesive tape prepared by the process according to claim 1.

16. The adhesive tape according to claim 15, which is a single-sided pressure-sensitive adhesive tape.

17. A method comprising adhering an adhesive tape according to claim 15 to a substrate.
